(19) United States
(12) Patent Application Publication
(10) Pub. No.: US 2007/0147040 A1
(43) Pub. Date: Jun. 28, 2007

(54) Compact fluorescent lamp reflector/concentrator

(76) Inventor: Vincent C.K. Leung, Hong Kong (CN)

Correspondence Address: ALIX YALE & RISTAS LLP, 750 MAIN STREET, SUITE 1400, HARTFORD, CT, 06103, US

(21) Appl. No.: 11/319,127

(22) Filed: Dec. 27, 2005

(51) Int. Cl. F21V 23/02

(52) U.S. Cl. 362/260

(57) ABSTRACT

A reflector/concentrator for a compact fluorescent lamp includes a concave reflector sized to hold a compact fluorescent lamp and having an opening at one end and a central longitudinal axis passing through the opening. The reflector has an internal reflective surface surrounding the axis and providing multiple focal points substantially along the axis from which light emanating from the compact fluorescent lamp can be reflected by the surface through the opening. There is a lens at or adjacent to the opening through which the reflected light passes.

### BACKGROUND OF THE INVENTION

The present invention relates to an electric light source reflector/concentrator for producing a narrow or divergent beam of light from a light source. More particularly, although not exclusively, the invention relates to a device for reflecting and concentrating light emitted by a compact fluorescent lamp.

It is known to reflect and concentrate light emitted by point light sources such as tungsten filament incandescent lamps and LEDs. Known devices comprise a shallow circular concave reflector at the central focal point of which the light source is positioned. Sometimes a transparent glass or plastics plate or diffuser is positioned in front of the light source to encase the light source within the reflector.

Incandescent electric lamps (“bulbs”/“globes”) are not efficient in converting electrical energy to light and LEDs require a low voltage power source such as a dry cell battery in a flashlight for example, or a transformer and rectifier in a domestic installation where high-voltage alternating current is provided.

Modern high-efficiency compact fluorescent lamps have been adopted in many light fittings in which diffused light emanates from the fluorescent lamp in all directions. Such compact fluorescent lamps do not provide a point light source of the type provided by incandescent lamps and LEDs and would therefore not ordinarily be regarded as suitable for use in a circular concave reflector of the type mentioned above.

### OBJECT OF THE INVENTION

It is an object of the present invention to overcome or substantially ameliorate at least one of the above disadvantages and/or more generally to provide a compact fluorescent lamp reflector/concentrator.

### DISCLOSURE OF THE INVENTION

There is disclosed herein a reflector/concentrator for a compact fluorescent lamp, comprising:
a concave reflector being sized to locate a compact fluorescent lamp therein and having an opening at one end and a central longitudinal axis passing through the opening and having an internal reflective surface surrounding the axis and providing multiple focal points substantially along the axis from which light emanating from the compact fluorescent lamp can be reflected by the surface through the opening, and
lens at or adjacent to the opening through which the reflected light passes.

Preferably, the reflective surface is multifaceted.

Preferably, the reflector is elongate along said axis.

### BRIEF DESCRIPTION OF THE DRAWINGS

A preferred form of the present invention will now be described by way of example with reference to the accompanying drawings, wherein:

FIG. 1 is a schematic parts-exploded perspective illustration of a compact fluorescent lamp reflector and lens,

FIG. 2 is a schematic perspective illustration of a flashlight incorporating the parts depicted in FIG. 1,

FIG. 3 is a schematic end elevation of the assembled parts depicted in FIG. 1, and

FIG. 4 is a schematic side elevation of the assembled parts depicted in FIG. 1.

### DESCRIPTION OF THE PREFERRED EMBODIMENT

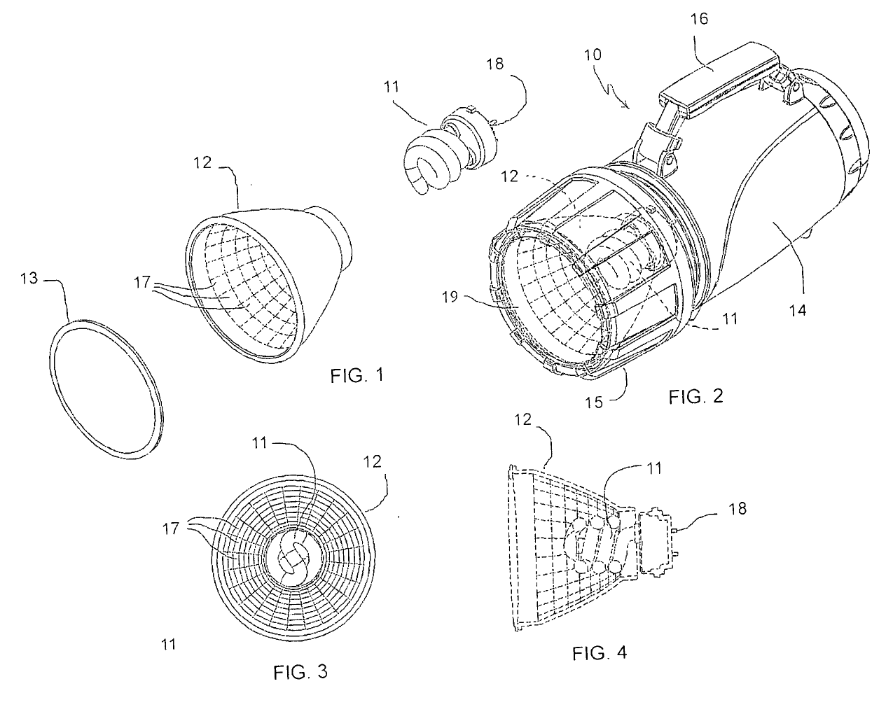

In FIG. 1 of the accompanying drawings there is depicted schematically and a compact fluorescent lamp 11 having electrical lugs 18 extending from a base. A coiled internally coated fluorescent tube extends from the other side of the base.

A reflector 12 includes a multifaceted internal reflective surface 17. There is an opening at the back of the reflector to receive the compact fluorescent lamp and the circular opening 19 at the front and through which light from the lamp 11 that is reflected by the reflective surface emanates. A lens 13 is fitted in front of the opening 19.

The reflector 12 is somewhat elongate when compared with the more squat reflectors known in the art and designed for use with single point light sources such as incandescent lamps. In effect, the reflector surrounds an imaginary longitudinal axis upon which the compact fluorescent lamp 11 is situated and around which the coils of the lamp are located. This axis would pass through the centre of the lens 13. Where an ordinary reflector would have a single focal point along its equivalent axis, the present reflector, being more elongate, provides multiple focal points or a “focal line or region” substantially along (and slightly about) the longitudinal axis so that light from the large light emitting surfaces of the compact fluorescent lamp's coil that are incident upon its multifaceted surface is properly reflected substantially parallel to the longitudinal axis.

The lens 13 may be contoured or flat.

A flashlight 10 embodying the invention is depicted in FIG. 2. The flashlight comprises a casing 14 and a handle 16. The parts depicted in FIGS. 1, 3 and 4 are located within a bezel 15 that is threaded upon the casing 14. The lens 13 is fixed in place by the bezel 15. In an embodiment not depicted but nevertheless envisaged, the lens 13 might be contoured and thereby designed to focus light. It this case, the reflector 12 would be fixed with respect to the casing 14. The lens 13 would move along the imaginary axis relative to the reflector upon rotation of the bezel to focus light reflected by the multifaceted surface 17 from the compact fluorescent lamp 11 as desired either into a thin or divergent beam. In another embodiment not depicted, although envisaged, the lens 13 could be flat and the reflector itself could be attached to the bezel so as to move in and out together with the lens relative to the fixed compact fluorescent lamp 11. The reflector, would move relative to the light source along the longitudinal axis of the reflector 12 to thereby focus the light passing through the lens into a narrow or divergent beam.

It should be appreciated that modifications and alterations obvious to those skilled in the art are not to be considered as beyond the scope of the present invention. For example, rather than providing a coiled compact fluorescent lamp, other forms of compact fluorescent lamp known in the art such as those having parallel elongate sections can be adopted.

1. A reflector/concentrator for a compact fluorescent lamp, comprising:
a concave reflector being sized to locate a compact fluorescent lamp therein and having an opening at one end and a central longitudinal axis passing through the opening and having an internal reflective surface surrounding the axis and providing multiple focal points substantially along the axis from which light emanating from the compact fluorescent lamp can be reflected by the surface through the opening, and
lens at or adjacent to the opening through which the reflected light passes.

2. The reflector/concentrator of claim 1, wherein the reflective surface is multifaceted.

3. The reflector/concentrator of claim 1, wherein the reflector is elongate along said axis.
